(19) United States
(12) Patent Application Publication
(10) Pub. No.: US 2005/0284338 A1
(43) Pub. Date: Dec. 29, 2005

(54) Hot melt adhesive

(76) Inventors: Patrick Ambrose Dwyer, Weddington, NC (US); David James Bowman, Charlotte, NC (US); Mary Elizabeth Cooper, Fort Mill, SC (US); Benjamin Donald Underwood, Albermarle, NC (US)

Correspondence Address: MACCORD MASON PLLC, 300 N. GREENE STREET, SUITE 1600, P. O. BOX 2974, GREENSBORO, NC, 27402, US

(21) Appl. No.: 10/858,520

(22) Filed: Jun. 1, 2004

(51) Int. Cl. C04B 14/38; C04B 16/00; E04B 1/62; C09J 11/04; C09J 11/06

(52) U.S. Cl. 106/711; 106/802; 156/71; 52/742.13

(57) ABSTRACT

An insulation material including a supply of material having discrete elements and an amorphous polyolefin hot melt adhesive for providing structure to the material having discrete elements, the amorphous polyolefin hot melt adhesive having a viscosity of less than about 400 centipoise at about 350° F. In the preferred embodiment of the invention, the supply of material having discrete elements is selected from the group consisting of fibrous material, granular material, pellet material, agglomerated material, aggregated material and mixtures thereof. Also, in the preferred embodiment, the amorphous polyolefin comprises greater than about 5 wt. % wax.

### BACKGROUND OF THE INVENTION

(1) Field of the Invention

The present invention relates generally to insulation materials and, more particularly, to an improved hot melt adhesive for providing structure to insulation materials having discrete elements.

(2) Description of the Prior Art

Insulation is used in residential and commercial dwellings both to conserve energy and to reduce noise. The two most common types of insulation are blown and batt. Blown insulation may be made from several lightweight natural or man-made materials. Batt insulation is most commonly made from fiberglass. Blown loose fill insulation is most often used for attic floors since the insulation is less expensive, more quickly installed and still allows access to wiring, etc.

Fiberglass batting is still preferred for non-horizontal and floor insulation since the batting holds the fiberglass in place. The fiberglass batting is applied in the cavity formed by vertical wall studs, an outer wall, a bottom sill and a top plate. Once the batt is fixed in position, a vapor barrier may be mounted over the insulated wall. Dry wall or other inner wall material is then mounted to the studs to complete the inner wall.

While loose fill insulation is more difficult to install in a non-horizontal wall, it may still be blown or spread within the stud cavity. Typically, the blown insulation is an aggregate of insulation particles mixed with wet adhesive or water to form a spray. However, since the insulation is loose and flowable, it is necessary to retain the insulation in position in the wall cavity prior to installation of the supporting skeletal wall or sheetrock.

One method was to utilize a perforated screen that was attached along the lower portion of the wall and moved upward as each section was completed. The perforated screen allowed the air being used to blow the insulation in place to escape but retained the loose fill insulation in place to allow the insulation to fill up behind the screen, dry and the water-based adhesive to set. This method has a number of drawbacks. First, it takes more time to put up the screening and more skilled labor than stapling a batt of fiberglass to the inside of a building structure. Also, there may be a substantial time delay in waiting for each section of insulation to dry and set before being able to move the screen to install the next section.

Another method was to utilize a plastic membrane to blow the loose insulation behind the membrane in the wall cavity. The insulation would then be tapped and packed in an effort to prevent future settling. Once the insulation was installed, the shield membrane was removed and dry wall or other wall materials could be applied to form the inner wall. This method had disadvantages, as well, because it required additional time delays and manpower to maintain the shield plate in position during installation of the insulation.

Still another method utilizes a netting material affixed to the wall studs to form an inner wall during the installation of the insulation. The netting is attached from floor to ceiling and forms a porous retaining barrier for the loose insulation to be blown in behind the netting. A hole was cut into the netting in order to receive the nozzle for delivery of insulation. Like the screen system, the netting permitted the air displaced by the positioned insulation to escape during the installation process. This method still has several disadvantages. For example, like the screen and membrane systems, the time involved with installing the retaining net is labor intensive and may not be easily done by just one person working alone.

As can be appreciated, blowing loose insulation material mixed with water and adhesive tends to be very messy and labor intensive in terms of cleanup. For example, the blow in methods very often cause insulation material to stick to the outer surface of the wall studs causing additional labor time to clean the stud face, in addition to a separate supply of water on the job site for the application process. In addition to the problems that water-based adhesives create for loose fill insulation, these systems can have inconsistent R values for the installation of the wall because of increased installed density of the insulation.

Thus, there remains a need for an insulation material including a supply of material having discrete elements which includes a hot melt adhesive which is sufficiently fluid for good atomization while, at the same time, solidifies quickly to provide structure to the material having discrete elements during insulation.

### SUMMARY OF THE INVENTION

The present invention is directed to an insulation material including a supply of material having discrete elements and a hot melt adhesive for providing structure to the material having discrete elements, the hot melt adhesive having a viscosity of less than about 400 centipoise at about 350° F. In the preferred embodiment of the invention, the supply of material having discrete elements is selected from the group consisting of fibrous material, granular material, pellet material, agglomerated material, aggregated material and mixtures thereof. Also, in the preferred embodiment, the hot melt adhesive is an amorphous poly olefin comprising greater than about 5 wt. % wax.

In the preferred embodiment, the hot melt adhesive may have a viscosity of between about 250 and 400 centipoise at about 350° F. The amount of wax may be between about 5 wt. % and about 20 wt. %. Preferably, the amount of wax is between about 5 wt. % and about 10 wt. %. Most preferably, the amount of wax is about 7½ wt. %. The wax may be a polyolefin wax.

In the preferred embodiment, the supply of material having discrete elements may be inorganic. The inorganic material may be selected from the group consisting of fiberglass, rock wool, pearlite, mineral wool, asbestos, and mixtures thereof. The supply of material having discrete elements may be organic. The organic material may be a natural material. The natural material may be cellulosic. The supply of material having discrete elements may be a non-conductive material. The non-conductive material may be a thermally non-conductive material. The non-conductive material may be an acoustically non-conductive material. The non-conductive material may be an electrically non-conductive material.

Accordingly, one aspect of the present invention is to provide an insulation material including: a supply of material having discrete elements; and a hot melt adhesive having a viscosity of less than about 400 centipoise at about 350° F. for providing structure to the material having discrete elements.

Another aspect of the present invention is to provide an amorphous polyolefin hot melt adhesive for providing structure to a material having discrete elements, the amorphous polyolefin hot melt adhesive comprising greater than about 5 wt. % wax and having a viscosity of less than about 400 centipoise at about 350° F.

Another aspect of the present invention is to provide an insulation material comprising: a supply of material having discrete elements selected from the group consisting of fibrous material, granular material, pellet material, agglomerated material, aggregated material and mixtures thereof; and an amorphous polyolefin hot melt adhesive for providing structure to the material having discrete elements, the amorphous polyolefin hot melt adhesive comprising greater than about 5 wt. % wax and having a viscosity of less than about 400 centipoise at about 350° F.

Another aspect of the present invention is to provide a method of installing an insulation material including a supply of material having discrete elements, the method comprising the steps of: providing a supply of material having discrete elements; and activating a hot melt adhesive having a viscosity of less than about 400 centipoise at about 350° F. for providing structure to the material having discrete elements during installation.

Still another aspect of the present invention is to provide a method of installing an insulation material including a supply of material having discrete elements, the method comprising the steps of: receiving the material into an inlet of a nozzle and applying the material to a surface from the outlet of the nozzle; and activating a hot melt adhesive having a viscosity of less than about 400 centipoise at about 350° F. to provide structure to the material having discrete elements during installation.

Yet another aspect of the present invention is to provide a method of installing an insulation material including a supply of material having discrete elements, the method comprising the steps of: providing a supply of material having discrete elements; transporting the supply of material having discrete elements to an applicator assembly, the applicator assembly including: (a) a nozzle having an inlet for receiving the material and an outlet for applying the material to a surface; and (b) an adhesive applicator adjacent to the nozzle; and activating a hot melt adhesive having a viscosity of less than about 400 centipoise at about 350° F. for providing structure to the material having discrete elements during installation.

These and other aspects of the present invention will become apparent to those skilled in the art after a reading of the following description of the preferred embodiment when considered with the drawings.

### BRIEF DESCRIPTION OF THE DRAWINGS

FIG. 1 is a side view of an insulation material constructed according to the present invention;

FIG. 2 is a graph of Atomization Quality of the Insulation Material as a Function of the Percent by Weight Wax of the Amorphous Polyolefin;

FIG. 3 is a graph of the Solidification Time of the Insulation Material as a Function of the Percent by Weight Wax of the Amorphous Polyolefin;

FIG. 4 is a graph of the Wall Adhesion Quality of the Insulation Material as a Function of the Percent by Weight Wax of the Amorphous Polyolefin; and

FIG. 5 is a graph of the Wall Adhesion Quality of the Insulation Material as a Function of the Percent by Weight Wax and Viscosity in Centipoise of the Amorphous Polyolefin.

### DESCRIPTION OF THE PREFERRED EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

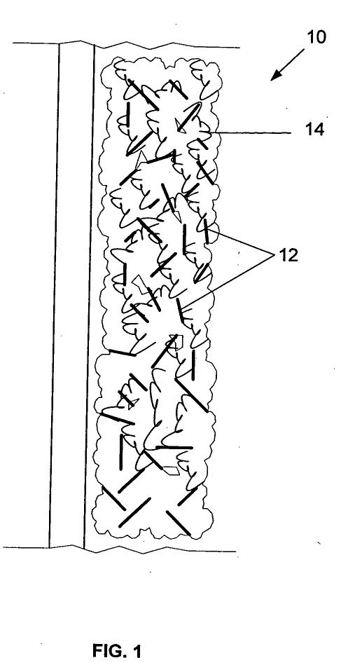

Referring now to the drawings in general and FIG. 1 in particular, it will be understood that the illustrations are for the purpose of describing a preferred embodiment of the invention and are not intended to limit the invention thereto. As best seen in FIG. 1, an insulation material, generally designated 10, is shown constructed according to the present invention. The insulation material 10 includes a supply of material having discrete elements 12 and a hot melt adhesive 14 having a viscosity of less than about 400 centipoise at about 350° F. for providing structure to the material having discrete elements. In the preferred embodiment, the hot melt adhesive is an amorphous polyolefin hot melt adhesive 14 comprises greater than about 5 wt. % wax.

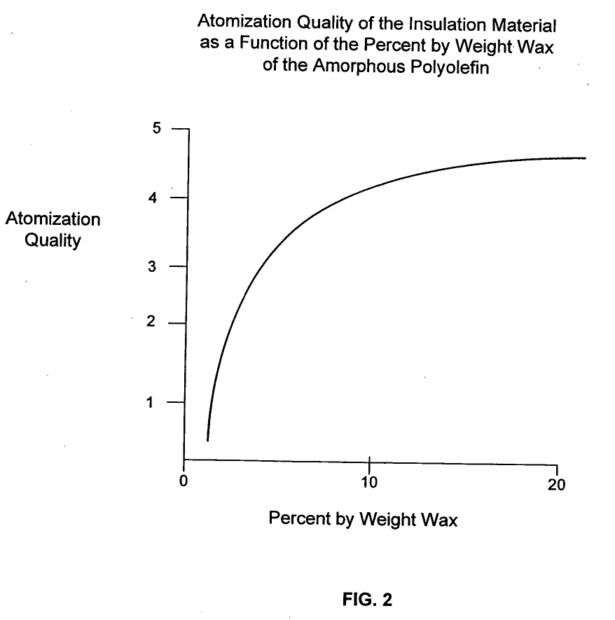

In the preferred embodiment, the amorphous polyolefin hot melt adhesive is available under the trade name 53-520M1 from The Reynolds Company of Greenville, S.C. As will be appreciated from a review of the graphs shown in FIGS. 2-5 and the discussion below, other hot melt adhesives may also be suitable if the viscosity of the hot melt adhesive at the given application temperature is in the correct range.

Generally, a higher melting temperature hot melt adhesive cannot be handled very well by most applicator equipment since conventional hose materials cannot take much higher temperatures on a sustained basis. Also, a lower melting temperature hot melt adhesive (at an equal viscosity) sets up too quickly.

The molecular weight of the hot melt adhesive may have an affect but it is not yet know if it is critical. Hot melt adhesives may or may not have a specific MW range. For example, in the present invention, the preferred amorphous polyolefin hot melt adhesive is a mixture of different polymers, so it is the viscosity at a given application temperature that is characterizable and not the molecular weight of the formulation.

The supply of material having discrete elements 12 may be selected from the group consisting of fibrous material, granular material, pellet material, agglomerated material, aggregated material and mixtures thereof. The supply of material having discrete elements 12 may be inorganic. The inorganic material may be selected from the group consisting of fiberglass, rock wool, pearlite, mineral wool, asbestos, and mixtures thereof. The supply of material 12 may be organic. The organic material may be a natural material. The natural material may be cellulosic. The supply of material having discrete elements 12 may be a non-conductive material. The non-conductive material may be a thermally non-conductive material, an acoustically non-conductive material, and/or an electrically non-conductive material.

FIG. 2 is a graph of Atomization Quality of the amorphous polyolefin hot melt adhesive as a function of the wt. % wax in the hot melt adhesive. The atomization quality of the amorphous polyolefin hot melt adhesive is represented by a number in the range of 1-5, with 5 representing the highest quality and 1 the lowest. It can be seen that the atomization quality of the amorphous polyolefin hot melt adhesive generally increases, but at a decreasing rate of increase, as the wt. % wax in the amorphous polyolefin hot melt adhesive is increased. Good atomization quality is achieved by the addition of about 5 wt. % wax.

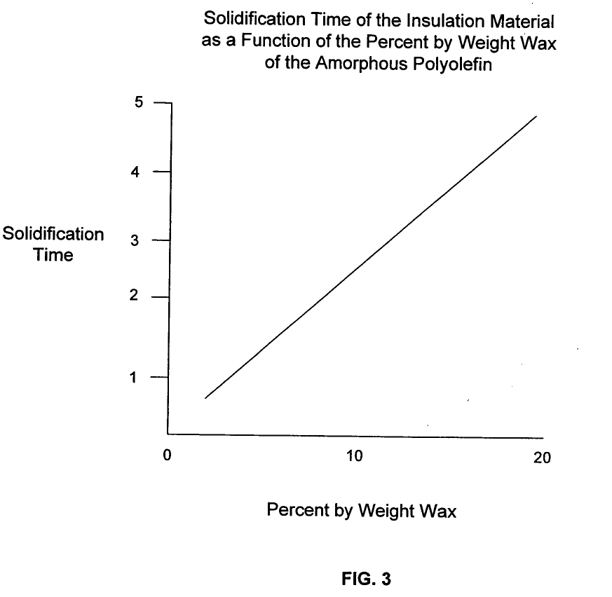

FIG. 3 is a graph of the Solidification Time of the insulation material as a function of the wt. % wax in the amorphous polyolefin hot melt adhesive. The solidification time of the insulation material is a measure of the time elapsing between the application of the insulation material and solidification of the insulation material to a level sufficiently fast to be desirable for blown in insulation applications. In FIG. 3, a number in the range of 1-5, with 5 the longest time period, and 1 the shortest, represents the solidification time of insulation material. As can be seen, the solidification time generally increases as the percent by weight wax of the amorphous polyolefin increases.

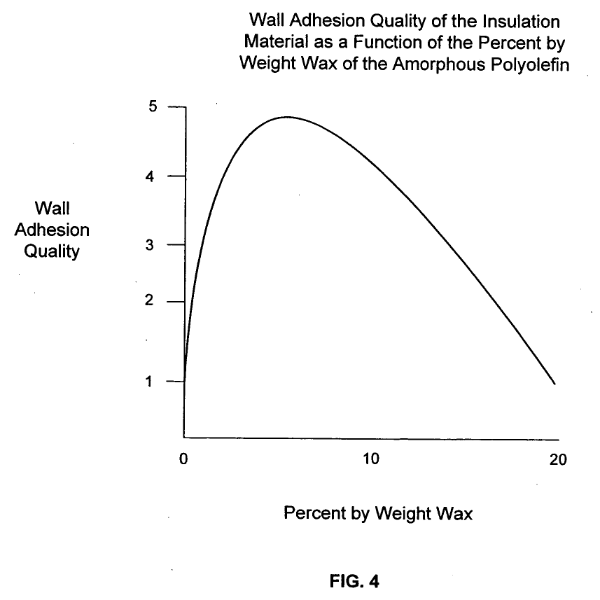

FIG. 4 is a graph of the Wall Adhesion Quality of the insulation material as a function of the wt. % wax in the amorphous polyolefin hot melt adhesive. The quality of the wall adhesion is represented by a number in the range of 1-5, with 5 representing the highest quality and 1 the lowest. Wall Adhesion Quality appears to be a function of many variables, including, but not limited to, the insulation material itself, the viscosity of the hot melt adhesive at application temperature and the solidification time of the hot melt adhesive. As can be seen, the highest quality wall adhesion was realized when the amorphous polyolefin hot melt adhesive comprised about 7½ wt. % wax.

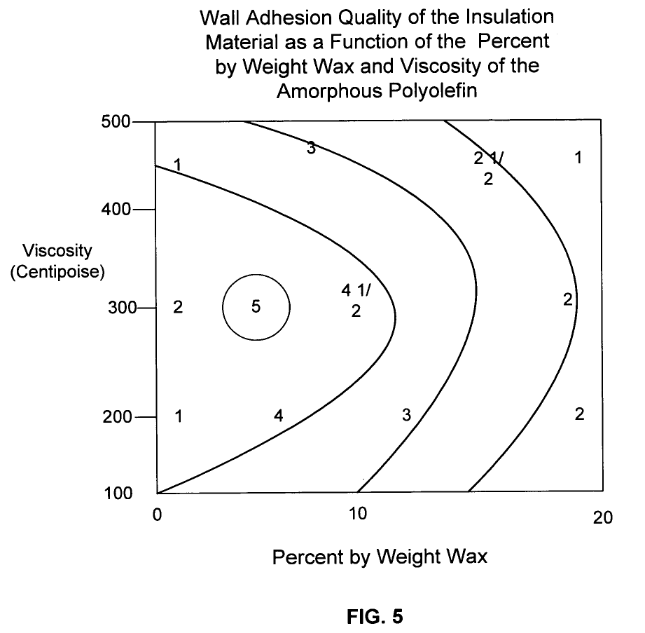

Finally, FIG. 5 is a graph of the Wall Adhesion Quality of the insulation material as both a function of the wt. % wax in the amorphous polyolefin hot melt adhesive and as a function of the viscosity in centipoise of the amorphous polyolefin hot melt adhesive. The quality of the wall adhesion is represented by a number in the range of 1-5, with 5 representing the highest quality and 1 the lowest. As can be seen, the insulation material has the highest quality wall adhesion when the amorphous polyolefin comprises greater than about 5 wt. % wax and has a viscosity of less than about 400 centipoise at about 350° F. In particular, the highest quality wall adhesion is realized when the amorphous polyolefin hot melt adhesive comprises about 7½ wt. % wax and has a viscosity of between about 250 and about 400 centipoise at about 350° F.

The insulation material of the present invention can be formed by various devices. In the preferred embodiment, suitable devices are set forth in U.S. Ser. No. 10/334,685, filed Dec. 31, 2002, now U.S. Pat. No. ______ and U.S. Ser. No. 10/700,356, filed Nov. 3, 2003, now U.S. Pat. No. ______. Both disclosures are hereby incorporated by reference in their entirety.

One method for installing the insulation material including a supply of material having discrete elements comprises the steps of: providing a supply of material having discrete elements; and activating a hot melt adhesive having a viscosity of less than about 400 centipoise at about 350° F. for providing structure to the material having discrete elements during installation.

Another method of installing the insulation material including a supply of material having discrete elements comprises the steps of: receiving the material into an inlet of a nozzle and applying the material to a surface from the outlet of the nozzle; and activating an amorphous polyolefin having a viscosity of less than about 400 centipoise at about 350° F. to provide structure to the material having discrete elements during installation.

Another method of installing the insulation material including a supply of material having discrete elements comprises the steps of: providing a supply of loose fill installation material having discrete elements; transporting the supply of material having discrete elements to an applicator assembly, the applicator assembly including: (a) a nozzle having an inlet for receiving the material and an outlet for applying the material to a surface; and (b) an adhesive applicator adjacent to the nozzle; and activating an amorphous polyolefin having a viscosity of less than about 400 centipoise at about 350° F. for providing structure to the material having discrete elements during installation.

Certain modifications and improvements will occur to those skilled in the art upon a reading of the foregoing description. For example, lower density insulation materials, such as fiberglass, may be formed with a broader range of viscosity hot melt adhesives. Also, while amorphous polyolefin is the preferred hot melt adhesive, other hot melt adhesives having the preferred characteristics set forth in the Figures may perform similarly. For example, there are several other classes of hot melt adhesives (HMA) other than amorphous polyolefin (APO), such as styrene-butadiene rubber (SBR), etc. All such modifications and improvements have been deleted herein for the sake of conciseness and readability but are properly within the scope of the following claims.

1. An insulation material comprising:
(a) a supply of material having discrete elements; and
(b) a hot melt adhesive having a viscosity of less than about 400 centipoise at about 350° F. for providing structure to the material having discrete elements.

2. The insulation material according to claim 1, wherein said supply of material having discrete elements is selected from the group consisting of fibrous material, granular material, pellet material, agglomerated material, aggregated material and mixtures thereof.

3. The insulation material according to claim 2, wherein the supply of material having discrete elements is inorganic.

4. The insulation material according to claim 3, wherein said inorganic material is selected from the group consisting of fiberglass, rock wool, pearlite, mineral wool, asbestos, and mixtures thereof.

5. The insulation material according to claim 2, wherein said supply of material having discrete elements is organic.

6. The insulation material according to claim 5, wherein said organic material is a natural material.

7. The insulation material according to claim 6, wherein said natural material is cellulosic.

8. The insulation material according to claim 1, wherein said supply of material having discrete elements is a non-conductive material.

9. The insulation material according to claim 8, wherein said supply of non-conductive material is a thermally non-conductive material.

10. The insulation material according to claim 8, wherein said supply of non-conductive material is an acoustically non-conductive material.

11. The insulation material according to claim 8, wherein said supply of non-conductive material is an electrically non-conductive material.

12. An amorphous polyolefin hot melt adhesive for providing structure to a material having discrete elements, the amorphous polyolefin hot melt adhesive comprising greater than about 5 wt. % wax and having a viscosity of less than about 400 centipoise at about 350° F.

13. The adhesive according to claim 12, wherein the adhesive has a viscosity of between about 250 and 400 centipoise at about 350° F.

14. The adhesive according to claim 12, wherein the amount of wax is between about 5 wt. % and about 20 wt. %.

15. The adhesive according to claim 14, wherein the amount of wax is between about 5 wt. % and about 10 wt. %.

16. The adhesive according to claim 15, wherein the amount of wax is about 7½ wt. %.

17. The adhesive according to claim 12, wherein the wax is a polyolefin wax.

18. An insulation material comprising:
(a) a supply of material having discrete elements selected from the group consisting of fibrous material, granular material, pellet material, agglomerated material, aggregated material and mixtures thereof; and
(b) an amorphous polyolefin hot melt adhesive for providing structure to the material having discrete elements, the amorphous polyolefin hot melt adhesive comprising greater than about 5 wt. % wax and having a viscosity of less than about 400 centipoise at about 350° F.

19. The insulation material according to claim 18, wherein the supply of material having discrete elements is inorganic.

20. The insulation material according to claim 19, wherein said inorganic material is selected from the group consisting of fiberglass, rock wool, pearlite, mineral wool, asbestos, and mixtures thereof.

21. The insulation material according to claim 18, wherein said supply of material having discrete elements is organic.

22. The insulation material according to claim 21, wherein said organic material is a natural material.

23. The insulation material according to claim 22, wherein said natural material is cellulosic.

24. The insulation material according to claim 18, wherein said supply of material having discrete elements is a non-conductive material.

25. The insulation material according to claim 24, wherein said supply of non-conductive material is a thermally non-conductive material.

26. The insulation material according to claim 24, wherein said supply of non-conductive material is an acoustically non-conductive material.

27. The insulation material according to claim 24, wherein said supply of non-conductive material is an electrically non-conductive material.

28. The insulation material according to claim 18, wherein the adhesive has a viscosity of between about 250 and 400 centipoise at about 350° F.

29. The insulation material according to claim 18, wherein the adhesive comprises between about 5 wt. % and about 20 wt. % wax.

30. The insulation material according to claim 29, wherein the adhesive comprises between about 5 wt. % and about 10 wt. % wax.

31. The insulation material according to claim 30, wherein the adhesive comprises about 7½ wt. % wax.

32. The insulation material according to claim 18, wherein the wax is a polyolefin wax.

33. A method of installing an insulation material including a supply of material having discrete elements, said method comprising the steps of:
(a) providing a supply of material having discrete elements; and
(b) activating an amorphous polyolefin having a viscosity of less than about 400 centipoise at about 350° F. for providing structure to said material having discrete elements during installation.

34. A method of installing an insulation material including a supply of material having discrete elements, said method comprising the steps of:
(a) receiving said material into an inlet of a nozzle and applying said material to a surface from the outlet of said nozzle; and
(b) activating an amorphous polyolefin having a viscosity of less than about 400 centipoise at about 350° F. to provide structure to said material having discrete elements during installation.

35. A method of installing an insulation material including a supply of material having discrete elements, said method comprising the steps of:
(a) providing a supply of material having discrete elements;
(b) transporting said supply of material having discrete elements to an applicator assembly, said applicator assembly including: (i) a nozzle having an inlet for receiving said material and an outlet for applying said material to a surface; and (ii) an adhesive applicator adjacent to said nozzle; and
(c) activating an amorphous polyolefin having a viscosity of less than about 400 centipoise at about 350° F. for providing structure to said material having discrete elements during installation.
